(19) United States
(12) Patent Application Publication
(10) Pub. No.: US 2013/0122480 A1
(43) Pub. Date: May 16, 2013

(54) SYSTEM AND METHOD OF APPLYING INTERMITENT REINFORCEMENT TO STUDENT DURING INSTRUCTIONAL ACTIVITY

(71) Applicant: Linda Louise Hanrahan, Concord, NH (US)

(72) Inventor: Linda Louise Hanrahan, Concord, NH (US)

(21) Appl. No.: 13/675,279

(22) Filed: Nov. 13, 2012

Related U.S. Application Data
(60) Provisional application No. 61/559,269, filed on Nov. 14, 2011.

(51) Int. Cl. G09B 5/02

(52) U.S. Cl. CPC G09B 5/02
USPC 434/322; 434/308

(57) ABSTRACT

A method and system for instructive reinforcement for a learner. The method comprises the steps of a) identifying a learner requiring external reinforcement for maintaining focus on an instructional activity; b) determining a reinforcement for the learner for use as an intermittent reinforcement during an instructional activity; c) defining at least one of a frequency and a duration of the intermittent reinforcement to be utilized during the instructional activity; d) performing the instructional activity; e) periodically interrupting the instructional activity, with the intermittent reinforcement, to refocus the learner back to the instructional activity; f) continuing performance of the instructional activity; and g) repeating steps e) and f) until the instructional activity is completed. A system incorporating the method is also disclosed.

### PRIORITY

This application is claims priority to U.S. Provisional Patent Application No. 61/559,269 filed Nov. 14, 2011.

### FIELD OF THE INVENTION

The present invention relates to a system and a method of applying intermittent reinforcement to a student during an instructional activity thereby to improve the attentiveness of the student, during the instructional activity, and thereby improve the overall learning of the student.

### BACKGROUND OF THE INVENTION

It is to be appreciated that learning is positively influenced by reinforcement which is a widely known and accepted technique. The type of reinforcement varies from student to student and/or individual to individual and possibly from activity to activity. In other words, the reinforcement that one educator might select for a first student might not be what the student responds to and/or prefers. Preference and choice of reinforcement is a very large issue particularly for a student or individual who has autism or is on the spectrum.

The inventor observed individuals with autism, for example, having a proclivity towards media. Films, cartoons, games and other two dimensional materials tend to interest such individuals the most. The also inventor observed that autistic children, at a very early age, became fascinated with videos, movies and games, particularly those containing Disney® characters or cartoon figures. These forms of media are often one of a small handful of things autistic children will be quieted by or exhibit an ability to be attentive to for long periods of time. In addition, the inventor often heard autistic children repeating dialogue verbatim from the movies/videos/games that they have watched.

The concept of applied intermittent reinforcement was conceived during a consultation regarding one male student with autism. The inventor noticed that it was difficult to find a mechanism of reinforcing this student. He was not reinforced by many of the usual reinforcement techniques conventionally offered in the classroom or running in the programs he uses in class. Instead it was observed that the student found watching his favorite video, e.g., “Winnie the Pooh,” to be most reinforcing. This was problematic in that the video is quite long and he was interested in watching the entire video, not just a portion of it. It also interfered with the instructional activities of the day within the classroom and also might not be seen as age appropriate for this student.

The student, during this consultation, was given an IPad® for classroom work and as a potential communication device. The student repeatedly demonstrated the capacity to go online and download the reinforcement that he preferred most. Even after all available means for access to the internet had been terminated on the IPad® that the student was using, the student was still able to navigate the IPad® and turn settings back on to what the student desired. This provoked the inventor to ask the question, “How do we get reinforcement that is preferential to the student, into an academic activity of the student without the reinforcement interfering with the student's academic work?”

When the inventor attempted to “mock up” the experience for the student, the inventor found that the student was indeed motivated and reinforced by the unpredictable occurrence of his “favorite” material. It was also determined by the inventor that the student would continue to be reinforced by the repeated intermittent showing of such “favorite” material to the student during the learning process.

The difficulty is how to develop or implement the preference for this kind of media, as reinforcement, without losing a learner to the reinforcement itself. Also, the removal of the reinforcement by an adult can antagonize and upset the student/learner and thus interfere with the programming or the instructional activity. Moreover, the inventor determined that if a learner perceives the interruption as a taking away of a desired experience or as a punishment, this can actually negatively impact the learner's performance and ability to learn. Ideally, to best serve the learner, the administration and removal of the reinforcement material would be completely independent of the adult/educator working with the learner. In other words, the reinforcement would ideally come and go intermittently and independently without any real and/or perceivable intervention and/or action by the adult/educator. While these same concepts are applicable to all individuals attempting to learn or work at something that is not intrinsically motivating for the learner, the system appears to be particularly effective for individuals with autism spectrum disorder.

One challenge is that many of the reinforcing materials that learners appear to prefer are copyrighted videos, games, music or other media. A second challenge is that if an educator allows the learner to control the access to the preferred material, the learner is tempted to exclusively watch/play the preferred reinforcing material, instead of expending the mental energy to remain attentive to and focus on and learn from the instructional activity. Another challenge is that the intervening reinforcement could interfere with an instruction program, which normally contains curriculum goals and objectives, thereby detracting from the overall learning that the learner is experiencing.

### SUMMARY OF THE INVENTION

Wherefore, it is an object of the present invention to overcome the above mentioned challenges.

Another object of the present invention is to provide a learning system/technique which runs in tandem, preferably in the background, behind a primary program that the learner is viewing for a learning purpose.

Yet another object of the present invention is to (1) engage the learner so that the educator may identify which media is/are reinforcing for a particular learner, (2) determine if such media is/are available within the world of applications or programs, (3) access those desired materials that are preferential for the particular learner or individual, (4) bring those materials into the instructional activity that the educator deems important to the learner's education or individual's work, (5) intermittently—when the learner become distracted—bring the reinforcement into the instructional activity, (6) control the amount of time during which the preferential stimuli occurs during the instructional activity, (7) contrive a schedule for when such reinforcement will intermittently occur that is unpredictable and, therefore, more reinforcing for the learner, (8) assess the necessary amount of exposure to the reinforcement needed by the learner in order to be effective, (9) assess this need on an individual basis, and (10) incorporate the assessment into the applied intermittent reinforcement.

A still further object of the present invention is to provide an intermittent reinforcement which is actually or seemingly independent of other individuals, within the room, in an effort to maintain a learner's/individual's interest in the instructional activity which may not be intrinsically motivating to the learner. Such intermittent reinforcement periodically occurs for a brief duration of time, during the course of the instructional activity, until such time as the instructional activity is eventually completed by the learner.

The present invention also relates to a system for facilitating instructive reinforcement for a learner, with an intermittent reinforcement, while viewing an instructional activity, the system comprising: an electronic device having an operating system for simultaneously operating both the instructional activity and the intermittent reinforcement; an external reinforcement, selected for the learner as the intermittent reinforcement during performance of the instructional activity, for returning an attention of the learner on the instructional activity; the electronic device including a mechanism for adjusting at least one of a frequency and a duration of the intermittent reinforcement to be utilized during the instructional activity; performing the instructional activity; periodically interrupting the instructional activity, with the intermittent reinforcement, to refocus the learner back to the instructional activity; continuing performance of the instructional activity; and repeatedly repeating the two previous steps until the instructional activity is completed.

### BRIEF DESCRIPTION OF THE DRAWINGS

The invention will now be described, by way of example, with reference to the accompanying drawings in which:

FIG. 1 is a diagrammatic flow diagram showing the basic features of the present invention; and

FIG. 2 is a diagrammatic view of one embodiment of an electric machine or device with which the present invention is preformed.

### DETAILED DESCRIPTION OF THE INVENTION

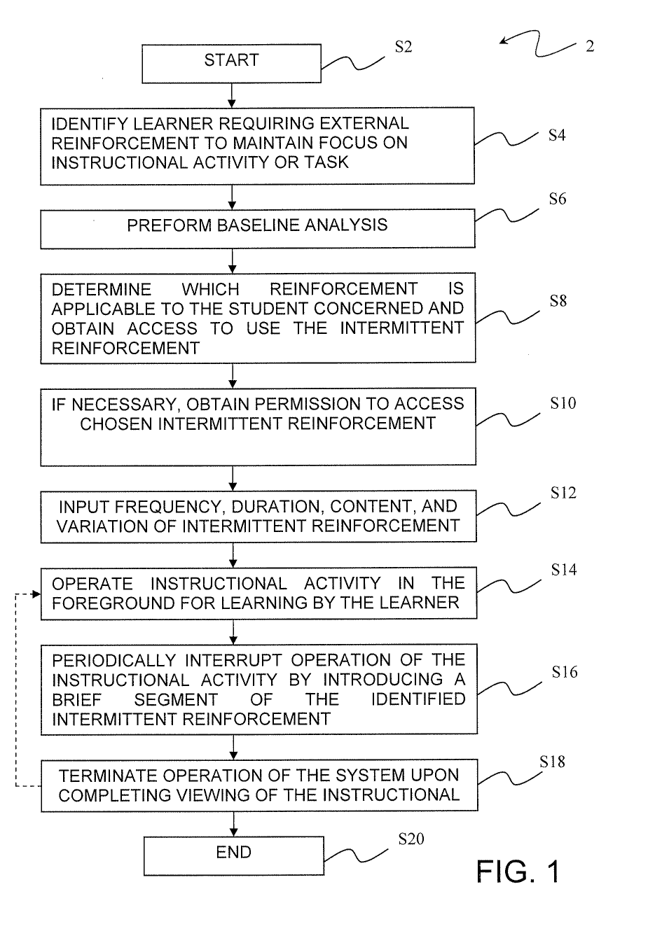

Turning now to FIG. 1, a brief description concerning the various components of the present invention will now be briefly discussed. As can be seen in this embodiment, the method generally relates to a system and a method 2 for providing intermittent reinforcement to a learner during a desired learning/instructional activity. The first step is to decide which learner/individual will “play” or benefit from this technique according to the present invention. That is, the individual learner must be identified as requiring external reinforcement, at step S4, in order to maintain the attention or focus of that learner on the instructional activity or task. Once this is determined, the educator, adult, parent or other person associated with the learner or individual concerned recognizes this need, and identifies the Applied Intermittent Reinforcement as a desired solution in addressing the learning disability of the learner.

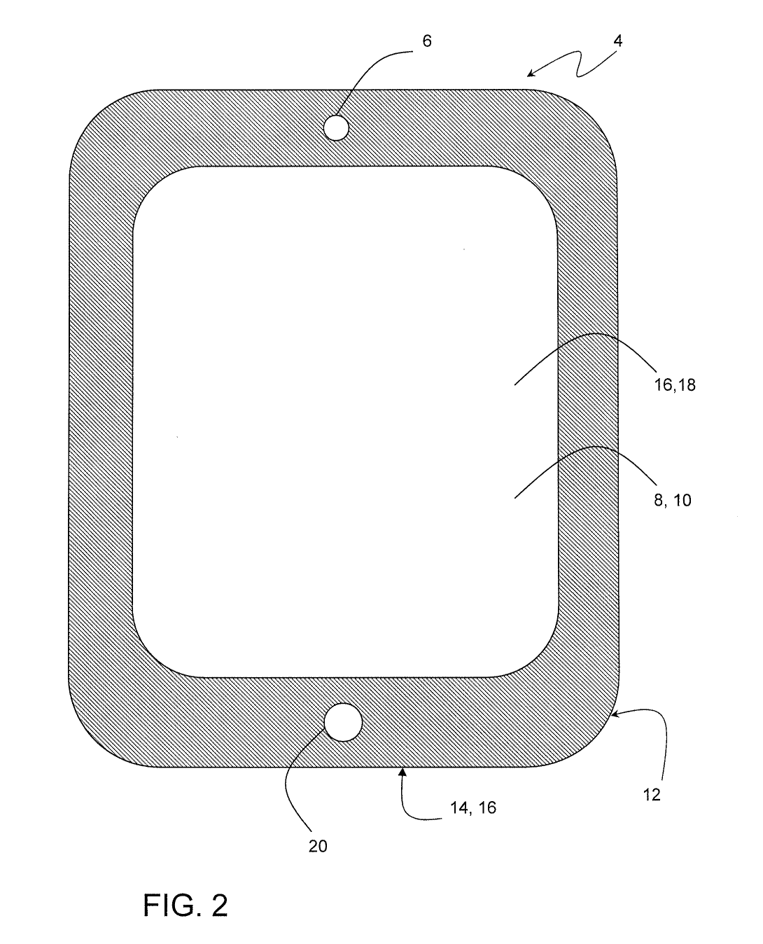

Once the learner is identified, necessary baseline data is acquired, at step S6. This baseline data includes, for example, a determination of how long the learner can work independently before that particular learner strays and becomes distracted from learning task at hand. One embodiment of the electronic machine or device 4, used to run the applied intermittent reinforcement material, is shown in FIG. 2 and is ideally also used to perform the underlying initial analysis for acquiring the baseline data. To acquire the baseline data, a video camera or a webcam 6, mounted to a screen 8 playing the instructional material, may be used to track eye movement/direction and/or facial movement/direction of the learner in order to gauge interest or disinterest in the currently displayed material. Additionally, the webcam 6 or a motion detection device can also monitor fidgety or antsy movement of the learner's limbs, head or extremities. When the learner's eyes and face are directed toward the screen, and the learner's eyes, face, and body are still, the learner will be interpreted as maintaining attention or focus. As the learner's eyes and/or face stray or are directed away from the screen, and/or start moving around out of sync with the instruction material, and/or the learner's limbs, head or extremities begin to exhibit fidgety or antsy movement, the learner will be interpreted as becoming distracted from the learning task at hand. Once the learner's eyes and/or face are substantially continuously directed away from the screen for a predetermined amount of time, e.g., 5 second, 10 seconds, 15 seconds, etc., or once the learner's eyes and or face are directed away from the screen for more than a maximum amount of time during a given span of time, e.g., from 15 seconds to over a 60 seconds for example, the learner will then be interpreted as having reached a point of distraction. Alternatively, the baseline data can be determined directly by an educator observing the learner while instructional material is being shown to that learner.

At the point of distraction, reinforcement is typically required so that the attention of the learner can then be returned back to and refocused on the learning task at hand. Additional baseline data would include a determination of how long the reinforcement needs, e.g., from a few seconds to possibly a minute or so, to be displayed to the learner in order for the learner to be sufficiently reengaged back into the learning task at hand, but not too long so that the learner becomes consumed by the reinforcement. Additionally, the type and content of the reinforcement(s) that work best for the individual learner also needs to be determined as part of the baseline data.

Step S8 requires the educator, adult or person associated with the learner or individual concerned to determine what is reinforcing to that learner or individual in the domain of the applied intermittent reinforcement as well as outside of the applied intermittent reinforcement. Once a suitable and accessible reinforcement is identified for the particular learner or individual, any necessary legal and proper permission or access to such suitable intermittent reinforcement, for the learner in question, is obtained, at step S10.

It is to be appreciated that the system and the method 2, according to the present invention, includes a wide range of possible default reinforcements which assist the educator, adult or person associated with the learner or individual concerned with determining what kind or type of reinforcement is applicable or suitable for that particular learner or individual in the domain of applied intermittent reinforcement as well as outside of applied intermittent reinforcement. Such default reinforcements are reinforcements in which prior accesses/permission has already been obtained and/or any copyright or other intellectual property right(s) in such reinforcement material is expired or otherwise terminated or generally available to the public. For example, the default reinforcements may include, but are not limited to, a variety of sensory and modality based experiences, meaning sight, hearing, touch and/or a variety of other pictures, photographs or other written material in which any previously existing copyright protection has expired. It is to be appreciated that the resources for the contemplated default reinforcements, according to the present invention, are virtually endless. Moreover, it is to be appreciated that if such default reinforcement(s) is/are protected by copyright, trademark or some other form of intellectual property, appropriate permission, e.g., licensing arrangement or agreement, is generally required in order to utilize or incorporate such intellectual property in the system and the method according to the present invention. The breadth of the availability of the different reinforcements does not minimize the importance of identifying the optimal reinforcement(s) for the particular student.

From the baseline data, at step S12 the instructor then inputs into the electronic machine or device (1) how frequently instructional program will be interrupted (e.g., once every 4 minutes, once every 6 minutes, once every 8.5 minutes, etc.), (2) for what duration (e.g., for 15 seconds, for 20 seconds, etc.), (3) what the content of the interruption will be (e.g., a small portion of a song, a 20 second video of the learner's favorite cartoon or character, etc.), and (4) any desired variations in frequency, duration, or content of reinforcement. For example, the interruption frequency could start at every four minutes, and decrease in frequency by, e.g., 10 seconds for each interruption, thereby increasing the length of time between interruptions as the instructional program. Additionally, the content could, at first, be an interactive game, then a video, then a song, then a cartoon, then an interactive game, etc. The level of interaction of the interruption content could also vary inversely with the level of projected distraction of the learner during the instructional program.

It is understood that generic baseline data could be employed if the learner is unable to undergo any baseline analysis or if such baseline analysis was inconclusive. When generic baseline data is used, the baseline data will be non specific to the given learner, but will generally correspond to the particular learner's age, sex, and psychological condition, if any. For example, for an eleven year male student with Asperger's syndrome, the instructor could input the above variables and previously assigned default frequency (e.g., once every 4 minutes), duration (e.g., for 15 second), content (e.g., “Winnie the Pooh”), and variation of intermittent reinforcement (e.g., randomly varying the frequency, the duration and the content for each interruption) would automatically be generated by the electronic device 4.

Alternatively, if the intermittent reinforcement was to be used with multiple learners on a single electronic device 4, where the multiple learners are of different demographics, the generic baseline data could vary based on the range of demographics. For example, if the age range of the learners was between 8 and 12 years old, and the sex was both male and female, the instructor could enter these variables and a specific default frequency, duration, content, and variation would automatically be generated, in a conventional manner by basic programming of the default settings, and used by the electronic device 4 during operation. When the intermittent reinforcement is used with multiple learners on a single device, it is understood that content will ideally be rated not just for level of appeal to specific ages, sexes, and physiological profiles, but if content would be unappealing to specific ages, sexes, and physiological profiles, such content would also be flagged as such and suitably removed. This way, with multiple learners sharing a single device 4, any content that was identified or determined to be unappealing and, in turn, distracting to one of the learners—even though it might be very appealing to one or more of the other learners—could be selectively removed and not utilized.

Different sections of the instructional program presentation could be rated for content complexity. When the content becomes more complicated to an average learner, it is more likely for a given learner to loose interest more rapidly. The electric device 4 could then be programmed to have an increasing frequency of interruption during sections of the instructional program rated or identified as more complicated and less frequent interruptions for less complicated rated sections of the program. The duration and the content of the interruption could also be varied based on the complexity of the different sections of the instructional program. With greater complexity, the duration may be longer and the content of the interruption could be more interactive and/or attention capturing for the learner.

Additionally, the frequency of the interruption could be either completely randomized, or preferably, randomized within a range of time, e.g. an interruption every 4 to 6 minutes, determined preferably by the learner's baseline data. The range then could be increased or decreased. The learning content could also be electronically tagged to prevent interruptions from occurring during key sections of the learning task at hand, and tagged to increase the likelihood of interruptions occurring in less critical sections of the learning task at hand.

The electronic device 4, on which the applied intermittent reinforcement is operated, can vary, but ideally contains output elements 10, like a video screen 8 and one or more speakers 12, a central processing unit 12, an operating system (not shown), a memory unit 14, and input elements 16, like a touch screen 18, one or more input buttons 20, a keyboard, a mouse (or mouse functioning input as used with laptops or mobile devices), a joy stick, a stylus, and a video camera or webcam 6. Common electric devices 4, that typically include one or more of the above elements and could potentially be used to perform the applied intermittent reinforcement, are a personal computer, a desktop, an IPad®, a smart phone, a special purpose computer, a tablet computer and an augmentative communication device.

Once the appropriate baseline data, demographic and/or interruption frequency, duration, content, and variation data are selected and then inputted into the electric device 4, the instructional program containing the learning task at hand is then started for the leaner, at step S14. The identified intermittent reinforcement is then periodically introduced during the instructional activity (e.g., operation of the instructional program containing the learning task at hand), during step S16. That is, the structural learning activity is typically a computerized program version which operates in the foreground to achieve the desired learning by the learner while the identified intermittent reinforcement operates in the background and only operates when prompted by the electronic device. Both the instructional activity program and the intermittent reinforcement program simultaneously operate, but the system and the method, according to the present invention, control operation of both of those programs so that only one is viewed by or displayed to the learner. The system and the method 2, once activated, will permit the main instructional activity program, containing the instructional program relating to the learning task at hand, to operate in the foreground for a predetermined period of time, e.g., for at least a few minutes to as much as 20 minutes or more, and then periodically interrupt further operation of the main instructional activity program.

As soon as the system or the method 2 interrupts the main instructional activity program, the system or the method 2 then immediately permits the intermittent reinforcement program to be viewed by or displayed to the learner for a brief duration of time, e.g., for a few seconds or so up to possibly a minute or so. Such interruption of the main instructional activity program, by the intermittent reinforcement program, is designed to capture and refocus the attention of the learner back to the computer screen for further learning by the learner. The preferred range of interruption, by the intermittent reinforcement program, is typically between about 10 to 30 seconds, or as long as necessary to regain the learner's attention.

Thereafter, the system and the method 2 then interrupts further viewing/displaying of the intermittent reinforcement program, and again initiates operation of the main instructional activity program so that the main instructional activity program then continues operating from the same point at which the main instructional activity program was interrupted. If desired, when initiating operation of the main instructional activity program, the system and the method 2 may reiterate the last 5 to 15 seconds of the main instructional activity program, immediately prior to the interruption by the intermittent reinforcement program, to refocus the learner back to the topic that was presented immediately prior to the interruption. The main instructional activity program will again continue operating for another predetermined duration of time, e.g., at least a few minutes to about 20 minutes or more before the main instructional activity program is again interrupted by the intermittent reinforcement program.

The intermittent reinforcements could also vary based on tracking of attention level of the learner from the electronic device 4. The number of correct answers or time of continued interaction with instruction with the instructional program is indicative of the learner's participation. The instructor will monitor the data from the instructional program and modify the intermittent reinforcement as needed to maximize success. Additionally, if the learner is concluded to be distracted or have a relatively low level of attention, the system and the method 2 can be modified to introduce intermittent reinforcement at a more frequent time interval, even if it is not yet time for an intermittent reinforcement to be viewed or displayed to the learner.

Procedure of intermittent reinforcement is repeated numerous times until viewing of the main instructional activity program, by the learner, is eventually completed, at step S18. At this point, the student's progress can be assessed and the instructor determines if the learner needs to reengage with the instructional content or began different instructional programming. The instructional program may then, returning to step S14, commence further learning for the learner with new or different material. If no additional content is to be covered or reviewed, the system and the method 2 continue to step S20 where the system and the method end.

It is to be appreciated that the duration of time that the main instructional activity program operates as well as the time that the intermittent reinforcement program operates both can be varied by the educator or adult to suit the particular learning needs of the learner or individual concerned and is, as indicated above, determined by the baseline data for the specific individual. That is, the duration of time that the main instructional activity program operates for learner or individual may be a shorter duration of time for younger learners and learners initially learning by the system and method according to the present invention while the duration of time that the main instructional activity program operates, between interruptions, will vary depending on the complexity and the length of the instructional content.

The advantageous elements of the applied intermittent reinforcement are that (1) the benefit of external reinforcement outside the instructional activity at hand, (2) the ability to access an unending array of mediums/media that are potentially reinforcing to suit the needs of the particular learner, (3) the availability of computer features/functionality that control the variables in implementing/utilizing the applied intermittent reinforcement effectively with a diverse population in a multitude of settings—including but not limited to education, work, and creative endeavors, (4) the inherent possibility of applying the applied intermittent reinforcement to other venues of computer-based interactions for the development and/or improvement of any skill in any population, (5) the scope of applications includes the use of multiple, mobile, post-personal computer technology, (6) the applied intermittent reinforcement has application for those individuals who use special purpose computers and access those computers with an alternative selection method, (7) the combination of future developments in applications for post personal computer technology, combined with the special needs of specific populations utilizing them, implies endless possibilities in the application of applied intermittent reinforcement, (8) applied intermittent reinforcement also has potential to be used as a screen saver for the learner.

The use of digital multimedia reinforcement via applied intermittent reinforcement also increases communicative competency in the learner using augmentative and alternative communication. The use of such customizable and individualized reinforcement as it applies to the teaching and learning process on special purpose speech generating devices and general-purpose post-PC mobile devices increases linguistic, strategic, social and operational competency.

According to the invention, the operating system will initially activate the instructional program or activity as well as the intermittent reinforcement program. The operating system will then initially commence operation or performance of the instructional program or activity in the visible foreground, as the primary operating program, with the intermittent reinforcement program being operated in a stand by mode in the non viewable background, as a secondary operating program. Then the operating system, as determined and guided by the entered inputs and other parameters of the present invention, will periodically temporarily interrupt or pause the instructional program or activity so that this program is no longer viewable by the learner (e.g., the instructional program or activity enters a stand by mode of operation), and then temporarily operate or perform the intermittent reinforcement program so that this program is now in the foreground and viewable by the learner for a brief duration of time, while further operation or performance of the instructional program or activity is temporarily suspended or paused. Once the brief duration of time expires, the operating system again resumes operation or performance of the instructional program or activity so that this program is now in the foreground and viewable by the learner while further operation or performance of the intermittent reinforcement program is suspended or paused and thus no longer viewable by the learner (e.g., the intermittent reinforcement program enters a stand by mode of operation), as described above.

Since certain changes may be made in the above described improved system and method of applying intermittent reinforcement to a learner during an instructional activity, without departing from the spirit and scope of the invention herein involved, it is intended that all of the subject matter of the above description or shown in the accompanying drawing shall be interpreted merely as examples illustrating the inventive concept herein and shall not be construed as limiting the invention.

Wherefore I claim:

1. A method of instructive reinforcement for a learner, the method comprising the steps of:
a) identifying a learner requiring external reinforcement for maintaining focus on an instructional activity;
b) determining a reinforcement for the learner for use as an intermittent reinforcement during an instructional activity;
c) defining at least one of a frequency and a duration of the intermittent reinforcement to be utilized during the instructional activity;
d) performing the instructional activity;
e) periodically interrupting the instructional activity, with the intermittent reinforcement, to refocus the learner back to the instructional activity;
f) continuing performance of the instructional activity; and
g) repeating steps e) and f) until the instructional activity is completed.

2. The method for instructive reinforcement according to claim 1, further comprising the step of using a video program, to be viewed by the learner, as the instructional activity.

3. The method for instructive reinforcement according to claim 1, further comprising the step of using one of a video, a song, a picture and a game, to be viewed by the learner, as the instructional activity.

4. The method for instructive reinforcement according to claim 1, further comprising the step of performing the instructional activity on one of a personal desk top computer, a laptop computer, a tablet computer, a mobile phone, a smart phone, an e-reader device and an augmentative communication device.

5. The method for instructive reinforcement according to claim 1, further comprising the step of establishing a base line attention time of the learner before starting instructional activity.

6. The method for instructive reinforcement according to claim 5, further comprising the step of establishing a base line intermittent reinforcement duration before commencing performance the instructional activity.

7. The method for instructive reinforcement according to claim 6, further comprising the step of setting a time span between intermittent reinforcement to be less than or equal to base line attention time of the learner.

8. The method for instructive reinforcement according to claim 6, further comprising the step of one of decreasing the intermittent reinforcement duration and increasing a time span between intermittent reinforcement as instructional activity proceeds from a beginning to an end.

9. The method for instructive reinforcement according to claim 6, further comprising the step of randomly varying the time span between successive intermittent reinforcements.

10. The method for instructive reinforcement according to claim 1, further comprising the step of tracking time of interaction by the learner with the instructional activity.

11. The method for instructive reinforcement according to claim 1, further comprising the step of moderating one of a frequency, a duration and a content of the intermittent reinforcement based upon a determined current level of interaction of the learner.

12. The method for instructive reinforcement according to claim 1, further comprising the step of inputting each of a frequency, a duration, a content and any desired variation of the intermittent reinforcement into an electronic device for performing both the instructional activity and the intermittent reinforcement.

13. A method of instructive reinforcement for a learner, the method comprising the steps of:
a) identifying a learner requiring external reinforcement for maintaining focus on an instructional activity;
b) performing baseline analysis on the learner to obtain baseline data;
c) determining a reinforcement for the learner for use as an intermittent reinforcement during an instructional activity;
d) obtaining any necessary permission to use the intermittent reinforcement;
e) defining at least one of a frequency and a duration of the intermittent reinforcement to be utilized during the instructional activity;
f) performing the instructional activity;
g) periodically interrupting the instructional activity, with the intermittent reinforcement, to refocus the learner back to the instructional activity;
h) continuing performance of the instructional activity; and
i) repeating steps g) and h) until the instructional activity is completed.

14. A system for facilitating instructive reinforcement for a learner, with an intermittent reinforcement, while viewing an instructional activity, the system comprising:
an electronic device having an operating system for simultaneously operating both the instructional activity and the intermittent reinforcement;
an external reinforcement, selected for the learner as the intermittent reinforcement during performance of the instructional activity, for returning an attention of the learner on the instructional activity;
the electronic device including a mechanism for adjusting at least one of a frequency and a duration of the intermittent reinforcement to be utilized during the instructional activity;
d) performing the instructional activity;
e) periodically interrupting the instructional activity, with the intermittent reinforcement, to refocus the learner back to the instructional activity;
f) continuing performance of the instructional activity; and
g) repeating steps e) and f) until the instructional activity is completed.
